(19) United States
(12) Patent Application Publication
(10) Pub. No.: US 2017/0269325 A1
(43) Pub. Date: Sep. 21, 2017

(54) OPTICAL COMPONENT MOUNTING FOR HIGH-G APPLICATIONS

(71) Applicant: Rosemount Aerospace Inc., Burnsville, MN (US)

(72) Inventor: Tim DeAngelo, Edina, MN (US)

(21) Appl. No.: 15/073,212

(22) Filed: Mar. 17, 2016

(51) Int. Cl. G02B 7/00; F41G 7/00

(52) U.S. Cl. CPC G02B 7/00; F41G 7/00

(57) ABSTRACT

An optical assembly for high-G application includes an optical element formed from a brittle material. A rigid frame with a channel surrounds the outer diameter region of the optical element. A compliant material fills the space between the rigid frame and the outer diameter region of the optical element to prevent physical contact between the rigid frame and optical element during a high-G event.

### BACKGROUND

The invention relates to optical mounting for use in high mode environments. In particular the invention relates to optical mounting in high-G or shock environments such as those encountered in large munitions.

Brittle optical elements in gun launched projectiles may be exposed to high shock loads in excess of 20,000 Gs. This loading is generally in the direction normal to these components and causes high internal stresses and presents a challenge to the survivability of the components. Stress concentrations at contact points in an optical assembly in a projectile are other sources of failure during a launch. Efforts to eliminate failure origins in optical elements will result in increased component survival in high-G environments.

### SUMMARY

An optical assembly for a high-G application includes an optical element formed from a brittle material. A rigid frame with a channel surrounds the outer diameter region of the optical element. A compliant material fills the space between the rigid frame and the outer diameter region of the optical element to prevent physical contact between the rigid frame and optical element during a high-G event.

In an embodiment, a method of forming an optical assembly for high-G application includes forming an optical element from a brittle material and forming a rigid channel that surrounds the outer perimeter region of the optical element. The method further includes filling the space between the optical element and the channel with a compliant material to prevent physical contact between the rigid frame and the optical element during a high-G event.

### BRIEF DESCRIPTION OF THE DRAWINGS

FIG. 1 is a schematic cross-section of an optical assembly with cast compliant material.

FIG. 2 is a schematic cross-section of an optical assembly with compliant material in the form of a gasket.

FIG. 3 is a cross-section of a structure containing multiple optical assemblies.

### DETAILED DESCRIPTION

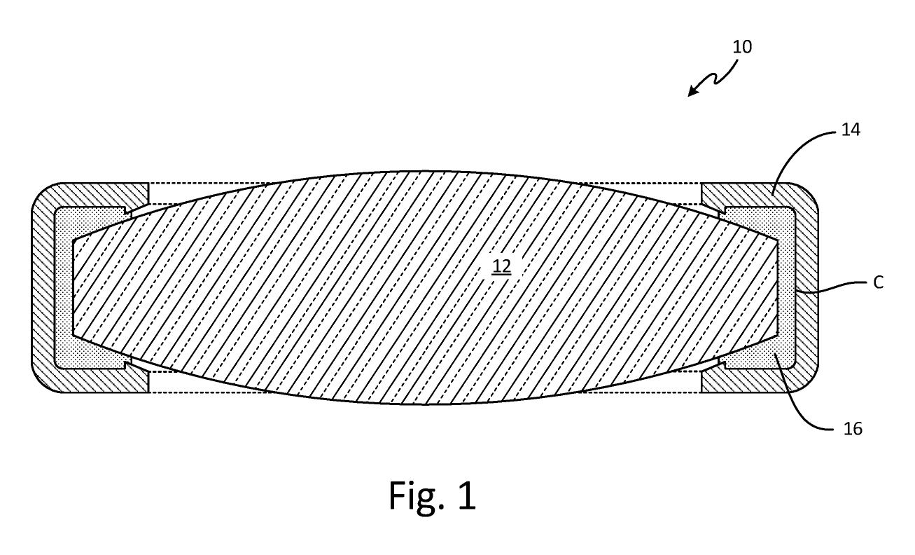

FIG. 1 is a schematic cross-section of optical assembly 10 according to an embodiment of the present invention. Optical assembly 10 may include circular optical element 12 surrounded by rigid body 14, wherein rigid body 14 contains channel C. Optical element 12 may be formed from a brittle material into a shape where it performs optical functions such as focusing, defocusing, imaging or other optical functions known in the art of image processing. Optical assembly 10 may be a sub-component, for instance, in a guidance system in a missile or gun launched munition. Optical assembly 10 may be an optical system operating at wavelengths ranging across the entire electromagnetic spectrum and preferably in the IR, visible and UV spectrums.

In order to “harden” optical assembly 10 against the inertial loads experienced, for instance, in a gun launch, optical component 12 may be designed to be protected against contact with a surface that would result in localized stress concentrations and possible fracture. As shown in FIG. 1, this isolation may be achieved by filling the space between optical component 12 and rigid body 14 with compliant material 16 that will protect optical component 12 from contact with rigid body 14 during an event such as a gun launch. Compliant material 16 may be silicone, epoxy, or other polymers such as urethanes, etc. In some applications, the materials may need to resist temperatures in excess of 200° C. due to the extreme conditions surrounding a projectile during a rocket or gun launch. Low melting temperature metals such as solders may be acceptable to resist the high-G loads (up to 20,000 Gs) experienced in some cases. The compliant material is selected so it will not permanently deform due to loads, so that optical performance does not degrade. The compliant material may be inserted by injection from an initial semisolid state or by casting from an initial liquid state.

Rigid body 14 may be a metal, ceramic, metal ceramic composite or other material known to those in the art. The metal may be a copper, aluminum, titanium alloy, or may be any structural metal in various embodiments.

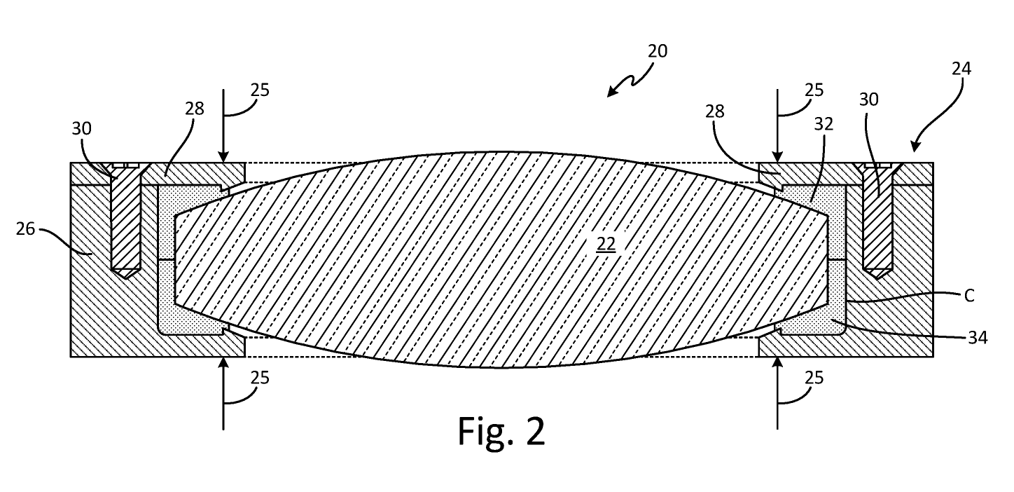

FIG. 2 is a schematic cross-section of optical assembly 20 according to another embodiment of the present invention. Optical assembly 20 may include optical element 22 surrounded by rigid body 24, wherein rigid body 24 may contain channel C. Rigid body 24 may further include cup shaped base 26 and lid 28 secured to base 26 with screws 30. Optical element 22 may be formed from a brittle material into a shape where it performs optical functions such as focusing, defocusing, imaging or other optical functions known in the art. Optical assembly 20 may be a sub-component of, for instance, a guidance system in a missile or gun launch munition. Optical assembly 20 may be an optical system operating at wavelengths ranging across the electromagnetic spectrum and preferably in the IR, visible and UV spectrums.

Optical assembly 20 may be “hardened” against inertial loads experienced for instance in a gun launch by preventing optical element 22 from coming into contact with rigid body 24 during a launch. This may be accomplished by filling the space between optical element 22 and rigid body 24 in channel C surrounding optical element 22 with a compliant material. In this embodiment, the compliant material may be in the form of a multi-piece gasket-like configuration comprising parts 32 and 34 surrounding optical element 22. To ensure close contact between parts 32, 34 and rigid body 24, the edges of rigid body 24 may be crimped by forcing the edges of rigid body 24 in the direction of arrows 25. In this embodiment, rigid body 24 may be formed of metal as mentioned above. Compliant parts 32 and 34 may be soft metal alloys, solder, ceramic based cements, silicone, epoxy, or other high temperature polymers such as urethanes, etc. Compliant parts 32 and 34 may also be a soft metal such as aluminum or copper alloys that may be fabricated to form a close fit to optical element 22 before being crimped in place to secure optical element 22. In this case, a thin layer of compliant material such as a polymer may be inserted between gasket parts 32 and 34 and optical element 22 to further ensure a close fit to eliminate stress concentrations in optical element 22 during the high-G loading of a launch event.

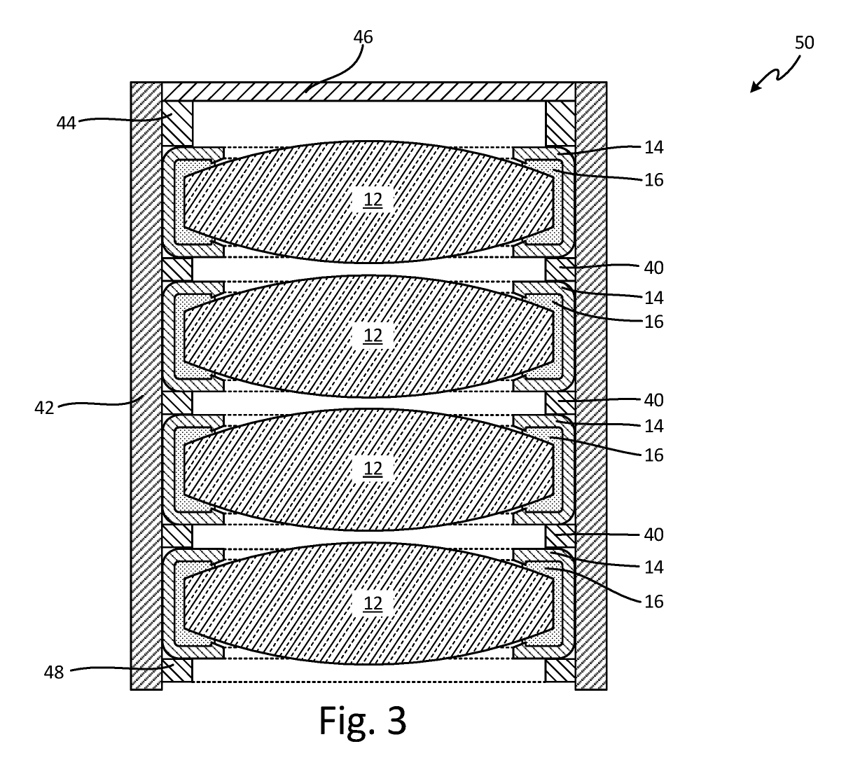

The design of optical assemblies 10, 20 and other similar assemblies allow hybrid multiple optical assemblies to be easily joined to enhance the diversity of an optical system. FIG. 3 is a schematic cross-section showing four optical assemblies 10 in hybrid optical assembly 50 with all components of each optical assembly 10 numbered as identified in FIG. 1. Each optical assembly 10 may be separated by a spacer 40 and may be surrounded by mounting cylinder 42. Window 46 may be mounted on spacer 44. Bottom spacer 48 may support the optical assemblies 10 in hybrid optical assembly 50. Each optical element 12 may be securely mounted in compliant material 16 and may be guarded against contact with adjacent metal rigid body 14 during a high-G event, as discussed above with respect to FIG. 1. All components in optical assembly 50 may be mounted in cylinder 42 by means well known in the field of optics by, for instance, threaded connections.

### DISCUSSION OF POSSIBLE EMBODIMENTS

The following are non-exclusive descriptions of possible embodiments of the present invention.

An optical assembly for high-G impact applications includes: an optical element formed from a brittle material; a rigid frame with a channel that surrounds outer regions of the optical element; and a compliant material that fills a space between the rigid frame and the outer regions of the optical element.

The assembly of the preceding paragraph can optionally include, additionally and/or alternatively any, one or more of the following features, configurations and/or additional components:

The compliant material may be injected or cast into the space between the rigid frame and the outer diameter regions of the optical element.

The compliant material is formed to match the shape and fill the space between the rigid frame and the outer regions of the optical element where the compliant material completely fills the space between the rigid frame and the outer regions of the optical element by crimping of the channel.

The optical assembly may be mounted in a fixture with additional optical assemblies to form a hybrid optical assembly.

The compliant material may be silicone, epoxy, urethane, materials used for casting shapes that originally flow to fill a void then set and cure such as polymers, cements, mortars, etc. and/or metals such as low melting point solders.

The compliant material may be silicone, epoxy, urethane, copper, or aluminum alloys or mixtures thereof.

The rigid frame may be metal.

The metal may be a copper, aluminum, or titanium alloy, any other structural metal or mixtures thereof.

A method of forming an optical assembly for high-G impact applications includes: forming an optical element from a brittle material; forming a rigid frame with a channel that surrounds an outer perimeter of the optical element; and filling a space between the optical element and the channel with a compliant material.

The method of the preceding paragraph can optionally include, additionally and/or alternatively any, one or more of the following features, configurations and/or additional components:

The compliant material may be injected or cast into the space between the rigid frame with the channel and the optical element.

The compliant material may be formed to fit the surrounding space between the rigid frame and the outer diameter region of the optical element where the compliant material completely fills the space between the rigid frame and the outer regions of the optical element by crimping of the rigid frame with the channel.

The optical assembly may be mounted in a fixture with additional optical assemblies to form a hybrid optical assembly.

The compliant material may be silicone, epoxy, urethane, materials used for casting shapes that originally flow to fill a void then set and cure such as polymers, cements, mortars, etc. and/or metals such as low melting solders.

The compliant material may be silicone, epoxy, urethane, copper, or aluminum alloys, or mixtures thereof.

The rigid material may be a metal.

The metal may be a copper, aluminum, or titanium alloy, any other structural metal or mixtures thereof.

An optical assembly for high-G application includes: an optical element mounted in compliant material in a rigid frame wherein the amount of compliant material is sufficient to prevent contact with the rigid frame during a high-G impact event.

The assembly of the preceding paragraph can optionally include, additionally and/or alternatively any, one or more of the following features, configurations and/or additional components:

An outer edge of the optical element is coated with the compliant material and is embedded in a groove in the rigid frame.

A compliant material may be silicone, epoxy, urethane, materials used for casting shapes that originally flow to fill a void then set and cure such as polymers, cements, mortars, etc. and/or metals such as low melting point solder.

The rigid frame may be metal.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. An optical assembly for high-G impact applications comprising:
an optical element formed from a brittle material;
a rigid frame with a channel that surrounds outer diameter regions of the optical element, the outer diameter regions including an outer diameter surface of the optical element and a perimeter portion of surfaces of the optical element adjacent to the outer diameter surface; and
a compliant material that fills a space between the rigid frame and the outer diameter regions of the optical element such that no portion of the optical element is in contact with the rigid frame.

2. The optical assembly of claim 1, wherein the compliant material is injected or cast into the space between the rigid frame and the outer diameter regions of the optical element.

3. The optical assembly of claim 1, wherein the compliant material is formed to match the shape and fill the space between the rigid frame and the outer regions of the optical element, the compliant material completely filling the space between the rigid frame and the outer regions of the optical element by crimping of the channel.

4. The optical assembly of claim 1, wherein the optical assembly is mounted in a fixture with additional optical assemblies to form a hybrid optical assembly.

5. The optical assembly of claim 2, wherein the compliant material comprises silicone, epoxy, urethane, materials used for casting shapes that originally flow to fill a void then set and cure such as polymers, cements, mortars, etc. and/or metals such as low melting point solders.

6. The optical assembly of claim 3, wherein the compliant material comprises silicone, epoxy, urethane, copper, or aluminum alloys or mixtures thereof.

7. The optical assembly of claim 1, wherein the rigid frame is metal.

8. The optical assembly of claim 7, wherein the metal comprises a copper, aluminum, or titanium alloy, any structural metal or mixtures thereof.

9. A method of forming an optical assembly for high-G impact applications comprising:
forming an optical element from a brittle material;
forming a rigid frame with a channel that surrounds an outer diameter regions of the optical element, the outer diameter regions including an outer diameter surface of the optical element and a perimeter portion of surfaces of the optical element adjacent to the outer diameter surface; and
filing a space between the circular optical element and the channel with a compliant material such that no portion of the optical element are in contact with the rigid frame.

10. The method of claim 9, wherein the compliant material is injected or cast into the space between the rigid frame with the channel and the optical element.

11. The method of claim 9, wherein the compliant material is formed to fit the surrounding space between the rigid frame and the outer diameter region of the optical element where the compliant material completely fills the space between the rigid frame and the outer regions of the optical element by crimping of the rigid frame with the channel.

12. The method of claim 9, wherein the optical assembly is mounted in a fixture with additional optical assemblies to form a hybrid optical assembly.

13. The method of claim 10, wherein the compliant material comprises silicone, epoxy, urethane, materials used for casting shapes that originally flow to fill a void then set and cure such as polymers, cements, mortars, etc. and/or metals such as low melting solders.

14. The method of claim 11, wherein the compliant material comprises silicone, epoxy, urethane, copper, or aluminum alloys or mixtures thereof.

15. The method of claim 9, wherein the rigid material is a metal.

16. The method of claim 15 wherein the metal comprises a copper, aluminum, or titanium alloy, any other structural metal or mixtures thereof.

17. An optical assembly for high-G applications comprising:
an optical element mounted in compliant material in a rigid frame, wherein the location and amount of compliant material is sufficient to prevent contact of the optical element with the rigid frame during a high-G impact event.

18. The optical assembly of claim 17, wherein an outer edge of the optical element is coated with the compliant material and is embedded in a groove in the rigid frame.

19. The optical assembly of claim 18, wherein the compliant material comprises silicone, epoxy, urethane, materials used for casting shapes that originally flow to fill a void then set and cure such as polymers, cements, mortars, etc. and/or low metals such as melting point solder.

20. The optical assembly of claim 17, wherein the rigid frame is metal.
